(19) United States
(12) Patent Application Publication
(10) Pub. No.: US 2024/0421327 A1
(43) Pub. Date: Dec. 19, 2024

(54) COMPOSITE PLATE FOR A FUEL CELL

(71) Applicant: Aerostack GmbH, Dettingen an der Erms (DE)

(72) Inventor: Jitendra Bhat-Hire, Dettingen an der Erms (DE)

(21) Appl. No.: 18/738,720

(22) Filed: Jun. 10, 2024

(30) Foreign Application Priority Data
Jun. 13, 2023 (DE) 102023115369.2

(51) Int. Cl. H01M 8/0228; H01M 8/0213; H01M 8/0215; H01M 8/0239; H01M 8/0254; H01M 8/2465

(52) U.S. Cl. CPC H01M 8/0228; H01M 8/0213; H01M 8/0215; H01M 8/0239; H01M 8/0254; H01M 8/2465; H01M 2250/20

(57) ABSTRACT

An end plate for a fuel cell includes a first layer forming an outer end plate layer, a second layer forming an abutting layer for a cell assembly of the fuel cell and a core. The outer end plate layer includes a first fiber composite structure providing structural tensile strength in a plane orientation of the outer end plate layer and forming a supporting structure to the abutting layer and the core. The abutting layer includes a second fiber composite structure providing structural tensile strength. The first fiber composite structure includes a first fiber material and the second fiber composite structure includes a different, second fiber material. The core and outer end plate layer provide torsional and/or bending stiffness to the end plate. The outer end plate layer and the abutting layer are each connected to the core in a laminar manner such that a sandwich plate is formed.

### TECHNICAL FIELD

The disclosure herein relates to an end plate, a fuel cell, an energy supply system and a method for manufacturing end plates for a cell assembly.

### BACKGROUND

Fuel cells that convert chemical to electrical energy may be deployed to power a wide range of vehicle systems. However, certain vehicle systems, like aircrafts, have difficulties in deploying fuel cells in view of their weight. Another aspect in relation to fuel cells in aircrafts are the requirements regarding stability to withstand possible physical conditions that may occur during operation of an aircraft, which requirements may result in bulky cell arrangements.

There may thus be a need for an improved fuel cell with a high stability, low weight and wide range of deployability.

### SUMMARY

The object of the disclosure herein is solved by the subject-matter and embodiments disclosed herein. It should be noted that the following described aspects of the disclosure herein apply also for the end plate, for the fuel cell and for the method for manufacturing of end plates for a cell assembly.

According to the disclosure herein, an end plate for a fuel cell is provided. The end plate comprises a first layer forming an outer end plate layer, a second layer forming an abutting layer for a cell assembly of the fuel cell and a core between the first layer and the second layer. The outer end plate layer comprises a first fiber composite structure providing structural tensile strength in a plane orientation of the outer end plate layer and forming a supporting structure to the abutting layer and the core. The abutting layer comprises a second fiber composite structure providing structural tensile strength in a plane orientation of the abutting layer. The abutting layer provides an electrical insulation for the abutting cell assembly, the abutting layer also providing a leak-tightness for media during operation of the fuel cell. The first fiber composite structure comprises a first fiber material and the second fiber composite structure comprises a second fiber material that is different than the first material. The core is provided as a sandwich core between the outer end plate layer and the abutting layer. The core along with the outer end plate layer provides the torsional and/or bending stiffness to the end plate. The core comprises a porous structure of a dielectric material comprising a plurality of volumes, the porous structure providing compressive strength. The outer end plate layer and the abutting layer are each connected to the core in a laminar manner, such that a sandwich plate is formed.

As an effect, the end plate provides high stability having less weight.

As an advantage, a light, stable and secure end plate for a cell assembly is yielded.

As an effect, the end plate provides low thermal expansion.

As an advantage, a more leak-tight connection of the end plate to the fuel cell is established.

As an advantage, less number of parts is provided to form the end plate.

As an advantage, core cells are electrically insulated.

As an advantage, a wide range of temperatures can be managed from −60 to between 180 and 200 degree Celsius.

As an advantage, up to 50% of weight with respect to the conventional method is saved.

According to an example, the first fiber composite structure comprises carbon fibers and the second fiber composite structure comprises glass fibers.

According to an example, the porous structure comprises a honeycomb structure.

According to an example, at least 50% of the pore volume comprises the filler material. Preferably, filled pore volume and unfilled pore volume are equally distributed across the porous structure.

According to the disclosure herein, also a fuel cell is provided. The fuel cell comprises a plurality of fuel cells arranged as a cell assembly, a lower plate and an upper plate, at least one fastening element and a plurality of current collectors. The cell assembly is arranged between the lower plate and the upper plate. The at least one fastening element secures the lower plate and the upper plate against each other such that the cell assembly is fixedly hold between the lower plate and the upper plate. The plurality of current collectors is arranged between the cell assembly and the lower plate and/or the upper plate. At least one of the lower plate and the upper plate is provided as an end plate according to one of the previous examples. The end plate faces the cell assembly with an abutting layer.

As a further advantage, a light, stable and secure cell assembly is yielded.

According to the disclosure herein, also an energy supply system is provided. The energy supply system comprises a fluid reservoir, a fluid supply and a fuel cell according to the previous examples. The fluid reservoir is configured to supply fluid, via the fluid supply to the fuel cell. The fluid supply is configured to be connected to the fuel cell. The fluid supply is configured to supply fluid and for discharge of exhaust gases. The end plates of the fuel cell are configured to provide access and connection for the fluid supply and electrical connections to the fuel cell. The fuel cell is configured to provide energy from the fluid by its electrical connections through the end plates.

According to the disclosure herein, also a method for manufacturing of end plates for a cell assembly is provided. The method comprises the following steps:
Providing a first layer forming an outer end plate layer;
Providing a second layer forming an abutting layer for the cell assembly;
Providing a core between the first layer and second layer. The outer end plate layer comprises a first fiber composite structure providing structural tensile strength in a plane orientation of the outer end plate layer and forming a supporting structure to the abutting layer and the core. The abutting layer comprises a second fiber composite structure providing structural tensile strength in a plane orientation of the abutting layer. The abutting layer provides an electrical insulation for the abutting cell assembly, the abutting layer also providing a leak-tightness for media during operation of the fuel cell. The first fiber composite structure comprises a first fiber material and the second fiber composite structure comprises a second fiber material that is different than the first material. The core is provided as a sandwich core between the outer end plate layer and the abutting layer. The core along with the outer end plate layer provides the torsional and/or bending stiffness to the end plate. The core comprises a porous structure of a dielectric material comprising a plurality of volumes, the porous structure providing compressive strength. The outer end plate layer and the abutting layer are each connected to the core in a laminar manner, such that a sandwich plate is formed. The current collector is joined to the abutting layer and the abutting layer is formed to overlap on the edge of the current collector, such that a sandwich plate is formed.

According to an aspect, a novel approach to build fuel cells using carbon fiber technology is provided. Carbon fiber possesses the welcoming properties of high tensile strength, low weight and can be manufactured as fiber composite structure. Though rigidity, electrical insulating capacity and leak-tightness with respect to fluid media are lacking. As carbon fibers can be used to manufacture composite materials, these properties however can be added to the composite material by other materials. As for example, rigidity and insulation may be provided by a material like reinforced paper or cellulose, like for example paper honeycomb structures. Leak-tightness may be provided by other materials that bind to the rigid and insulating material like paper, as for instance GFRP does. All together these materials interact to reinforce each other as part of a structural framework of a fuel cell. The structural framework provides a highly stable fuel cell at low weight or mass.

These and other aspects of the disclosure herein will become apparent from and be elucidated with reference to the embodiments described hereinafter.

### BRIEF DESCRIPTION OF THE DRAWINGS

Example embodiments of the disclosure herein will be described in the following with reference to the following drawings:

FIG. 1 schematically shows a cross section through an example of an end plate for a fuel cell.

FIG. 2 schematically shows an example of a porous structure of the core from FIG. 1.

FIG. 3 schematically shows a view on the abutting layer of an example of the end plate having media ports and an immersed current collector.

FIG. 4A schematically shows a cross section through the region where the lateral cover block of the media ports abuts the three layers of an example of the end plate.

FIG. 4B schematically shows a cross section through an example of the end plate with the immersed current collector.

FIG. 5 schematically shows an example of a fuel cell having the end plate as a lower plate and an upper plate.

FIG. 6 schematically shows an example of an energy supply system deploying the fuel cell.

FIG. 7 shows basics steps of a method for manufacturing of end plates for a cell assembly.

### DETAILED DESCRIPTION

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the example embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

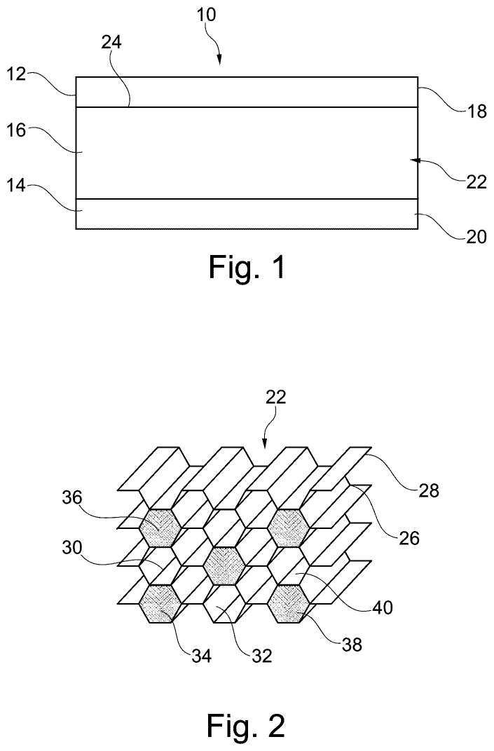

FIG. 1 schematically shows a cross section through an example of an end plate 10 for a fuel cell. The end plate 10 comprises a first layer forming an outer end plate layer 12, a second layer forming an abutting layer 14 for a cell assembly of the fuel cell and a core 16 between the first layer and the second layer. The outer end plate layer 12 comprises a first fiber composite structure providing structural tensile strength in a plane orientation of the outer end plate layer 12 and forming a supporting structure to the abutting layer 14 and the core 16. The abutting layer 14 comprises a second fiber composite structure providing structural tensile strength in a plane orientation of the abutting layer 14. The abutting layer 14 provides an electrical insulation for the abutting cell assembly, the abutting layer 14 also providing a leak-tightness for media during operation of the fuel cell. The first fiber composite structure comprises a first fiber material 18 and the second fiber composite structure comprises a second fiber material 20 that is different than the first material. The core 16 is provided as a sandwich core 16 between the outer end plate layer 12 and the abutting layer 14. The core 16 along with the outer end plate layer 12 provides the torsional and/or bending stiffness to the end plate 10. The core 16 comprises a porous structure 22 of a dielectric material comprising a plurality of volumes, the porous structure 22 providing compressive strength. The outer end plate layer 12 and the abutting layer 14 are each connected to the core 16 in a laminar manner (24), such that a sandwich plate is formed.

The “end plate” can also be referred to as cover, lid, cap, upper shell, end plate, top cover, cask cover, rear end cover, end plate, panel, disk, board, sheet slab outer end plates, compression plates, support structure.

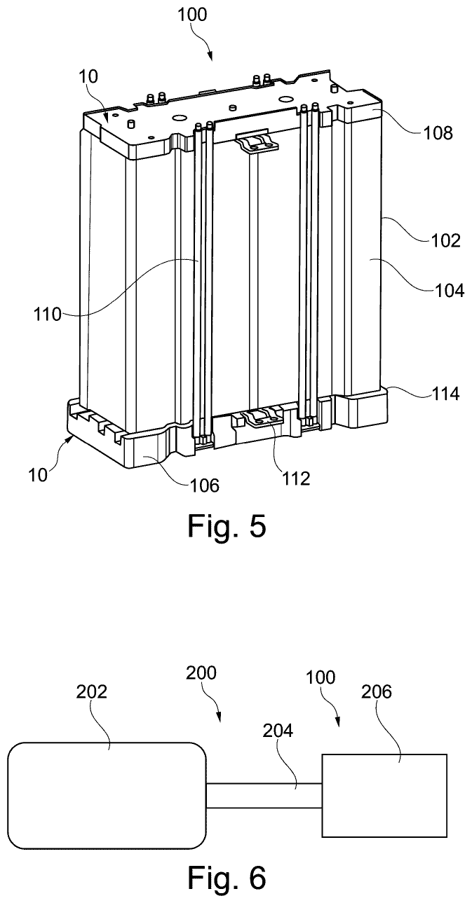

In an example, the end plate 10 represents a structural framework for the constructional stability of the cell assembly, as depicted later on in FIG. 5.

The “cell assembly” can also be referred to as cell components or cell stack.

The “fuel cell” can also be referred to as a component that converts the chemical energy of the fuel into electrical energy. The fuel cell can be operated with any substance providing energy, such as a fuel.

The “cell components” or “cell assembly” relates to an assembly of individual plates that form channels to the fuel and conduct electrical energy, not shown in FIG. 1.

The “fuel” can also be referred to as fluid or media.

In an example, the fuel is hydrogen.

In an example, the fuel is a hydrocarbon.

In an example, the fuel comprises nitrogen.

In an example, the fuel is air.

The “layer” can also be referred to as sheet, slab, component or coat.

The term “first layer” or “outer end plate layer” can be understood as the face of the end plate 10 pointing away to the outside, opposite to the cell components or cell assembly. It is not in contact with the cell stack or the electronic connections, current collectors or any other element of the cell components or cell assembly conducting an electric current, not shown in FIG. 1.

The term “second layer” or “abutting layer” can be understood as face of the end plate 10 pointing towards the cell assembly. It is in contact with the cell stack arrangement of the fuel cell. The second layer can be understood as connection portion of the end plate 10 to the cell components or cell assembly.

The “first layer” or “outer end plate layer” and “second layer” or “abutting layer” can also be referred to as layers.

The term “fiber composite structure” relates to a matrix comprising fibers. The fibers have a certain length, orientation, connection to each other, pattern or distribution in the matrix that can be described as structure. The fibers are not shown in FIG. 1.

In an example, the matrix is a polymer or a resin.

The term “structural tensile strength” relates to the stress that the layers can withstand while being stretched or pulled before breaking.

The term “plane orientation” relates to directions parallel to the

largest surface of the layer.

The term “torsional strength” relates to the stress that the layers can withstand while being twisted before breaking (resistance to the twisting movements).

The term “bending strength” relates to the stress that the layers can withstand while being deformed before breaking (resistance to deformation).

The term electrical insulation can also be referred to as isolation or electrical isolation.

The term “electrical insulation” relates to a property of the layers of preventing conduction of any electrical current, not shown in FIG. 1.

In an example, the end plate 10 comprises the first layer that comprises a fiber material for providing tensile strength. The fiber material also provides electric conductivity. Electrical conductivity is not desired with respect to end plates of fuel cells, since electrical conductivity might cause short cuts to the fuel cell by the end plate 10. Hence the fuel cell components, the cell assembly etc., that conduct electricity are separated, i.e., electrically insulated from the first layer by the second layer, i.e., the abutting layer 14 and the cover, not shown in FIG. 1. The second layer and the cover comprise dielectric materials to provide for the insulation from the electronic parts of the fuel cell.

The term “leak-tightness” relates to the property of forming a barrier against the fluid, i.e., the media from the fuel cell that cannot be overcome by penetrating the respective layer by channels, fractures or pores, not shown in FIG. 1.

In an example, the third layer, i.e., abutting layer 14 is leak-tight with respect to the media.

The term “fiber material” relates to any solid material, forming an elongated structure.

In an example, the fiber material comprises a mixture of different types of fibers, not shown in FIG. 1.

The term “different” relates to the properties of the fiber material of the first and the second layer. The material of the fibers of the first and second layer is different with respect to chemical or physical properties, e.g., the first layer comprises carbon fibers and the second layer comprises glass fibers.

In an example, the first fiber composite structure comprises conductive fibers, and the second fiber composite structure comprises non-conductive fibers, i.e., dielectric fibers.

The term “sandwich” relates to the orientation of the core 16 with respect to the first and the second layer, the core 16 being in between the first and the second layer, such that the first layer covers a surface of the core 16, and the second layer covers the other surface of the core 16. The core 16 separates the first layer from the second layer, as shown in FIG. 1.

The term “porous structure” relates to a plurality of hollow structures, i.e., pores, channels, tunnels, recesses, lumens and networks inside the core 16, that enhance the inner surface of the core 16 and provide space for a volume inside the core 16, and the volume does not comprise the material of the core 16, not shown in FIG. 1.

In an example, the core 16 provides a high ratio of insulation and structural stiffness to the end plate 10. This is achieved by a maximum of interconnections provided by pore wall material with respect to the volume filled out by the pores.

The term “plurality of volumes” relates to the space inside the core 16 structure that is not filled by the material of the core 16.

The “compressive strength” can also be referred to as resistance to pressure.

The “structural stiffness” can also be referred as the rigidness of the component or resistance to deformation.

The term “In-plane” relates to the direction parallel to the fiber direction or parallel to the largest face.

The term “Out of Plane” relates to the direction perpendicular to the fiber direction or perpendicular to the largest face. The term “laminar manner” relates to the way in which the layers are interconnected with each other. The layers are interconnected, or laminated with each other via their largest surface, such that, i.e., the largest surface or face of the first layers abuts the largest outer surface or face of the core 16. The fibers of the fiber composite structure of the first layer and the second layer extend in planar orientation, parallel to their largest surface.

The fiber structures of the first and the second layer extend parallel to the largest faces of the core 16, not shown in FIG. 1.

In an example, the first and second layer stick to the core 16 by adhesive forces.

In an example, a connection layer like an adhesive is provided between the core 16 and the adjacent, i.e., adjoining first and second layer.

In an example, the adhesive force is generated by heating the matrix material of the first and the second layer and then pressing the first and the second layer against the core 16, not shown in FIG. 1.

In an example, an interconnection between faces of the first and second layers as well as the core 16 is configured to form a unity of the three layers with their properties combined. The properties combined are the tensile strength of the first layer, the rigidness and the electric insulation effect of the core 16, the electric insulating effect and the leak-tightness of the second layer.

In an example, a composite material is yielded, as shown in FIG. 1.

In an example, the synergistic effect between the first layer, the second layer and the core 16 is a low thermal expansion among all three components combined to the composite material.

In an example, a composite material with an overall low thermal expansion is yielded.

In an example not shown in FIG. 1, first fiber composite structure comprises carbon fibers and the second fiber composite structure comprises glass fibers.

In an example, the carbon fibers provide high tensile strength.

In an example, the carbon fibers are conductive and the core 16 comprising dielectric material and the second layer with its glass fibers electrically insulate the carbon fibers from the electronic current of the cell assembly.

The first layer can thus be conductive, but the second layer is non-conductive, i.e., dielectric, not shown in FIG. 1.

As an advantage, carbon fiber-reinforced cell assembly can be provided.

In an example, the first fiber composite structure is CFRP.

In an example, the second fiber composite structure is GFRP with e or s-glass fibers.

FIG. 2 schematically shows an example of a porous structure 22 of the core 16 from FIG. 1. The porous structure 22 provides the plurality of volumes as pore volume 26 and pore walls 28.

In an option and preferably, the openings of pores 30 of the pore structure open towards the outer end plate layer 12 and the abutting layer 14.

In an option and preferably, the pore walls 28 extend traverse to the outer end plate layer 12 and the abutting layer 14.

The term “pore volume” relates to the overall volume of every pore and not the pore volume of a single pore.

In an example, the pores exclusively open up at the largest surface of core 16.

In another example, the pores exclusively open up at the lateral faces of the core 16, not shown in FIG. 2.

In an example, the pore walls 28 extend perpendicular from one largest face of the core 16 to the other largest face of the core 16.

In an example, the pore walls 28 extend perpendicular from one lateral face of the core 16 to the other lateral face of the core 16, not shown in FIG. 2.

In an example, the pore walls 28 and the pores comprise various shapes and the pore walls 28 come with various thicknesses.

In an example, axes of the pores cross in the core 16.

In an example, a part of the matrix material of the first and the second layer is taken up by the openings of the pores, to increase binding strength, not shown in FIG. 2.

In an example, a part of the fibers of the first and the second layer lurks inside the openings of the pores.

In an example, a foam structure is provided, e.g., with an open-cell structure or with a closed-cell structure.

In an example of FIG. 2, the porous structure 22 comprises a honeycomb structure 32.

In an example, the pore walls 28 comprise a hexagonal shape.

In an example, the pore walls 28 with the hexagonal shape extend perpendicularly from the first layer to the second layer.

In an example, openings of the pores of the honeycomb structure 32 are covered with a sheet of core 16 material, to increase stability of the honeycomb structure 32, not shown in FIG. 2.

In an example, the shape and geometry of pores varies in the pore structure.

In an example not shown in FIG. 2 the core 16 comprises cellulose.

In an example, a honeycomb made from cellulose material is provided, such as a paper honeycomb structure 32.

The term “cellulose” can also be referred to as paper.

In an example, the cellulose comprises additional substances to enhance tensile strength and/or rigidity, not shown in FIG. 2.

In an example, the cellulose comprises additional substances to enhance tensile strength and/or rigidity, when the cellulose is wet.

In an example, the surface of the cellulose core 16 is pre-treated in order to improve adherence to carbon fibers or glass fibers, i.e., CFRP or GFRP.

In an example, a paper foam structure is provided, e.g., with an open-cell structure or with a closed-cell structure, not shown in FIG. 2.

In an example, a lateral cover is provided for the core 16 to provide a sealing for the fuel. In an option, the lateral cover extends also across the lateral end faces of the first outer layer and the second outer layer. The lateral cover can also be referred to as end cover, side cover or ended side cover, not shown in FIG. 2 but as lateral cover block in FIG. 4A.

In an example, the lateral cover provides leak-tightness against hydrogen.

In an example, the lateral cover prevents fuel from entering the pores of the porous structure 22.

In an option, the lateral cover is provided as an L-formed cover overlapping an edge portion of the abutting layer 14.

In an example, the core 16 structure comprises wood, e.g., Ochroma wood or bamboo.

In an example, the core 16 comprises fire retardant substances.

In an option of FIG. 2, the core 16 further comprises reinforcement elements 34. The reinforcement elements are configured to structurally strengthen the pores.

In an example, fittings are provided to support the pore walls 28.

In an example, some pore walls 28 comprise thicker core 16 material.

In an example, the first and the second layer reinforce the pore structure of the core 16.

In an option of FIG. 2, the reinforcement elements 34 are provided as a filler material 36, the filler material 36 filling out at least a part of pore volume 26 of the core 16. The filler material 36 is configured to provide for compressive strength, structural stiffness and electric insulation.

The term “filler material” relates to a substance that conforms its shape to the pore walls 28 and pore volume 26 while being a fluid with a low viscosity and then being turned to a solid material or a fluid with very high viscosity.

In an example, the filler material 36 adheres to the pore walls 28.

The term “filler material” can also be referred to as filling.

In an example, the filler material 36 comprises a resin mixed with chopped glass fibers (short fibers), not shown in FIG. 2.

In an example, the filler material 36 further comprises a dielectric fiber material to provide for electric insulation.

In an example, the filler material 36 provides pores itself.

In a further option of FIG. 2, at least 50% of the pore volume 26 comprises the filler material 36.

In a further option and, preferably, filled pore volume 38 and unfilled pore volume 40 are equally distributed across the porous structure 22.

In an example, less than 50% of the pore volume 26 comprises the filler material 36, like e.g., 20, 30 or 40%.

In another example, all pore walls 28 are in contact with filler material 36.

In another example, all pores are filled with filler material 36.

In an example, the pore volume 26 of the pores is half-filled with filler material 36.

In an example, the filling of the pore volume 26 of the pores with the filler material 36 varies from pore to pore, not shown in FIG. 2.

In an example, the filler material 36 fills the pores, such that the pore walls 28 are covered with filler material 36, but a smaller pore volume 26 resides inside the filled pores.

In another example, the pores are fully filled with the filler material 36.

In an example, the filled pores are arranged at certain predetermined areas of the core 16.

In an example, the filler material 36 lurking out of the pore openings facilitates the adhesion of the first and the second layer to the core 16, not shown in FIG. 2.

In an example, the filler material 36 is the matrix material of the fiber component structure of the first and second layer.

In an example, the filler material 36 hampers fluids, like hydrogen from entering the pore volume 26.

In an example not shown in FIG. 2, the first fiber composite structure of the outer end plate layer 12 comprises symmetrical fiber layers comprising fiber orientations of 0, +−45, and 90 degrees.

In an option and preferably, the first fiber composite structure makes the outer end plate layer 12 quasi-isotropic.

In an example, the fibers are randomly distributed layer by layer.

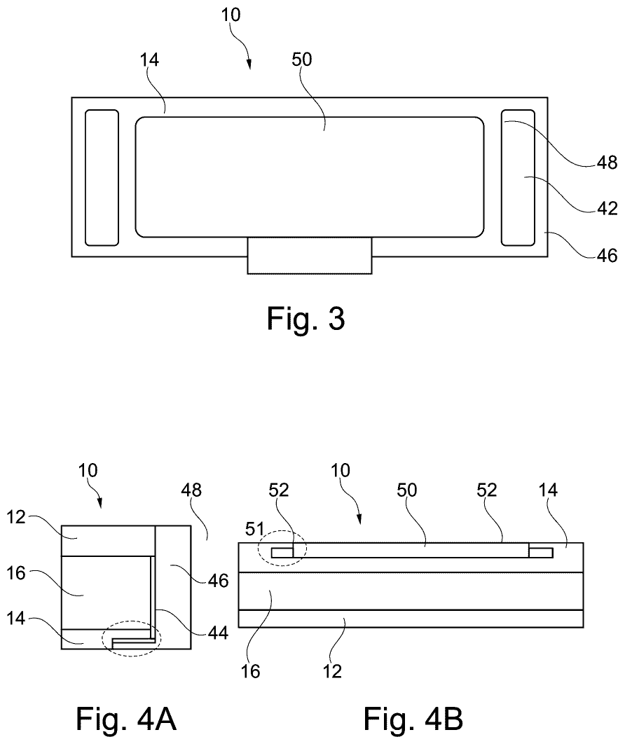

FIG. 3 schematically shows a view on the abutting layer 14 of an example of the end plate 10 having media ports and an immersed current collector. At least one media port 42 is provided in a lateral portion 44 of the abutting layer 14 for supplying fuel to the cell assembly. The at least one media port 42 is extending to an opposite face of the outer end plate layer 12, not visible in FIG. 3.

FIG. 4A schematically shows a cross section through the region where the lateral cover block of the media ports 42 abuts the three layers of an example of the end plate.

In an option and preferably, a lateral cover block 46 is provided having at least one void (48) forming the at least one media port 42 running lateral to an end face of the core 16 and the outer end plate layer 12. The lateral cover block 46 is shown in FIG. 3 as well.

The term “media port” relates to a cable guide or cable channel to guide supplies to the fuel cell through the end plate 10.

The term “lateral portion” relates to the smaller surface of the first layer or the second layer or the core 16, i.e., their side faces. The lateral portion 44 cuts through the fibers of the first layer and the second layer.

The term “lateral cover block” relates to a kind of veneer that blocks access for fluids to the lateral portion 44 of the end plate 10, i.e., hampers fluids like hydrogen from entering the pore structure of the core 16.

In an example, a cover layer is provided that comprises a resin layer that seals the lateral portion 44 of the end plate 10 in order to block fluid from leaking into the end plate 10.

In an example, the lateral cover block 46 is made of GFRP.

FIG. 4B schematically shows a cross section through an example of the end plate 10 with the immersed current collector 50. A current collector 50 for connecting cells of a cell assembly is provided at least partially embedded in the abutting layer 14. At least a part of a surface (52) of the current collector 50 is exposed to face the cell assembly.

In an option and preferably, the abutting layer 14 overlaps at least one side portion, shown by dashed circle 51 in FIG. 4B of the current collector 50 providing an engaging mount 52.

The term “current collector” relates to an element that receives or conducts electricity from the cell assembly of the fuel cell to electric conduits that supply electricity from the fuel cell.

In an example, the core 16 and the second layer are configured to electrically insulate the current collector 50 with respect to the first layer, i.e., the carbon fibers.

In an example, an end plate 10 according to the previous examples is provided. The first and second layer stick to the core 16 by adhesive forces. In addition, the first and second layer can also be joined through adhesive force at different regions thereby increasing the strength and better leakage protection against the media, not shown in FIG. 4B.

In an example the first and second layer can be joined at different locations with core 16 material comprising of the rest of the void volume between first and second layer.

FIG. 5 schematically shows an example of a fuel cell 100 having the end plate 10 as a lower plate 106 and an upper plate 108. The fuel cell 100 comprises a plurality of fuel cells 102 arranged as a cell assembly 104, a lower plate 106 and an upper plate 108, at least one fastening element 110 and a plurality of current collectors 112. The cell assembly 104 is arranged between the lower plate 106 and the upper plate 108. The at least one fastening element 110 secures the lower plate 106 and the upper plate 108 against each other such that the cell assembly 104 is fixedly hold between the lower plate 106 and the upper plate 108. The plurality of current collectors 112 is arranged between the cell assembly 104 and the lower plate 106 and/or the upper plate 108. At least one of the lower plate 106 and the upper plate 108 is provided as an end plate 10 according to one of the previous examples and options. The end plate 10 faces the cell assembly 104 with an abutting layer 114.

In an example, the end plates 106, 108 are attached to the connection portions at either end of the cell assembly 104 with their connection interface.

In an example, the end plates 106, 108 at either end of the cell

assembly 104 are fastened to each other by the fastening elements 110 to provide for structural stability of the fuel cell.

In an example, electrical connection terminals are provided for connecting the cell assembly 104 to a load, e.g., an electric drive, electrically operated components and equipment and the like. The electrical connection terminals are connected to the plurality of current collectors 112.

In an example, the connection interfaces of the end plates 106, 108 are configured to fasten the end plates 106, 108 to the cell assembly 104 by the fastening elements 110 and to provide access for the electrical connections.

In an example, the lower plate and the upper plate 108 are configured to be secured against each other by shear and/or bending and/or torque and/or tension forces and/or preload forces.

In an example of FIG. 5, the lower plate 106 and the upper plate 108 are both provided as an end plate 10 according to one of the claims 1 to 11.

FIG. 6 schematically shows an example of an energy supply system 200 deploying the fuel cell. The energy supply system 200 comprises: a fluid reservoir 202, a fluid supply 204 and a fuel cell 206 according to one of the previous examples and options. The fluid reservoir is configured to supply fluid, via the fluid supply to the fuel cell 206. The fluid supply is configured to be connected to the fuel cell 206. The fluid supply is configured to supply fluid and for discharge of exhaust gases. The end plates 106, 108 of the fuel cell 206 are configured to provide access and connection for the fluid supply and electrical connections to the fuel cell 206. The fuel cell 206 is configured to provide energy from the fluid by its electrical connections through the end plates 106, 108.

In an example, the energy supply system 200 is configured to provide energy for an aircraft on a mission.

In an example, the plates possess media ports or channels in order to guide supplies to the cell assembly 104. These ports and channels are covered by a lateral cover to prevent substances from entering the inside of the end plate 10, not shown in FIG. 6.

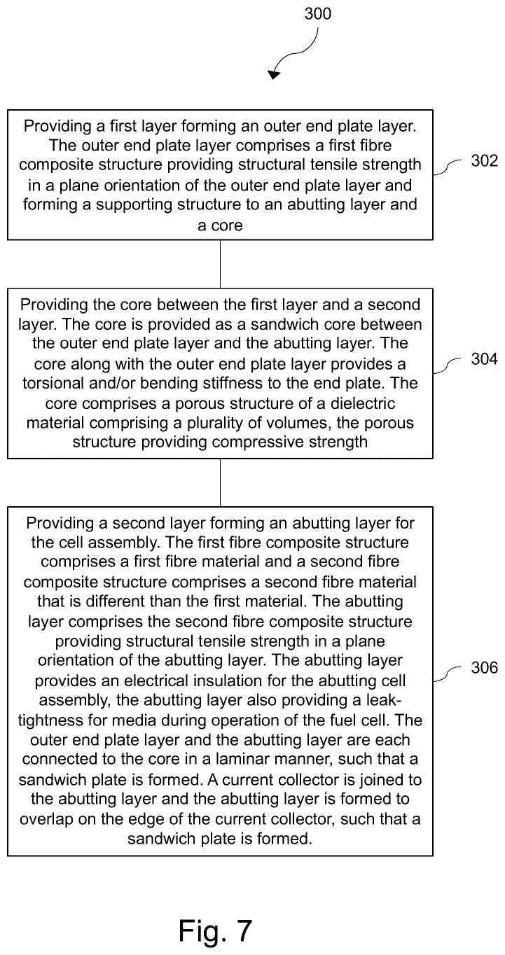

FIG. 7 shows basics steps of a method 300 for manufacturing of end plates 106, 108 for a cell assembly 104. The method comprises the steps:
In a first step 302 a first layer forming an outer end plate layer 12 is provided. The outer end plate layer 12 comprises a first fiber composite structure providing structural tensile strength in a plane orientation of the outer end plate layer 12 and forming a supporting structure to an abutting layer 14 and a core 16,
In a second step 304 the core 16 is provided between the first layer and a second layer. The core 16 is provided as a sandwich core 16 between the outer end plate layer 12 and the abutting layer 14. The core 16 along with the outer end plate layer 12 provides a torsional and/or bending stiffness to the end plate. The core 16 comprises a porous structure 22 of a dielectric material comprising a plurality of volumes, the porous structure 22 providing compressive strength,
In a third step 306 a second layer forming an abutting layer 14 for the cell assembly 104 is provided. The first fiber composite structure comprises a first fiber material 18 and a second fiber composite structure comprises a second fiber material 20 that is different than the first material. The abutting layer 14 comprises the second fiber composite structure providing structural tensile strength in a plane orientation of the abutting layer 14. The abutting layer 14 provides an electrical insulation for the abutting cell assembly 104, the abutting layer 14 also providing a leak-tightness for media during operation of the fuel cell 100. The outer end plate layer 12 and the abutting layer 14 are each connected to the core 16 in a laminar manner 24, such that a sandwich plate is formed. A current collector 50 is joined to the abutting layer 14 and the abutting layer 14 is formed to overlap on the edge of the current collector 50, such that a sandwich plate is formed.

In an example of the method, the lateral cover block 46 which forms the void to the media is joined to the sandwich panel during the layer build up.

The term “lateral cover block” is integrated into the sandwich during the ply build up.

The “lateral cover block” is either made up of several layer of GFRP or can be used as a single solid block.

In an example, the media port 42 is formed through machining of the later cover block.

In an example, before adding the current collector 50 and a layer of overlapping GFRP on the abutting layer 14 side, the end plate 10 outer edges are machined. This is to ensure the precise outer edge for the current collector 50 positioning.

In an example, the first fiber composite structure providing structural tensile strength in a plane orientation has different directional properties.

In an example, the first fiber composite structure provides structural stiffness to the abutting layer and the core.

In an example, the individual lamina, i.e. the fiber orientation, of the outer end plate layer are connected to each other through adhesive.

In an option of the method, the core comprises partially filled cells using a filler material in combination with fibers which provide the compressive strength to the structure.

In an example, the abutting layer is joined to the core material through adhesive.

In an example, the current collector 50 is provided as an embedded feature on the abutting layer facing the cell assembly.

In an example, the current collector is joined to the abutting layer and the additional single layer of the second fiber material is formed to overlap on the edge of the current collector, such that a sandwich plate is formed.

In an example, the additional single layer is attached to the existing abutting layer and the outer edge of the current collector through adhesive.

In an example, the outer edge of the sandwich plate where the core material's open cells are visible, is covered with filler material to prevent any absorption of humidity.

It has to be noted that embodiments of the disclosure herein are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or example and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An end plate for a fuel cell, the end plate comprising:
a first layer forming an outer end plate layer;
a second layer forming an abutting layer for a cell assembly of the fuel cell; and
a core between the first layer and the second layer;
wherein the outer end plate layer comprises a first fiber composite structure providing structural tensile strength in a plane orientation of the outer end plate layer and forming a supporting structure to the abutting layer and the core;
wherein the abutting layer comprises a second fiber composite structure providing structural tensile strength in a plane orientation of the abutting layer;
wherein the abutting layer provides an electrical insulation for the abutting cell assembly, the abutting layer also providing a leak-tightness for media during operation of the fuel cell;
wherein the first fiber composite structure comprises a first fiber material and the second fiber composite structure comprises a second fiber material that is different than the first material;
wherein the core is a sandwich core between the outer end plate layer and the abutting layer;
wherein the core along with the outer end plate layer provides torsional and/or bending stiffness to the end plate;
wherein the core comprises a porous structure of a dielectric material comprising a plurality of volumes, the porous structure providing compressive strength; and
wherein the outer end plate layer and the abutting layer are each connected to the core in a laminar manner, such that a sandwich plate is formed.

2. The end plate according to claim 1, wherein the first fiber composite structure comprises carbon fibers; and
wherein the second fiber composite structure comprises glass fibers.

3. The dnd plate according to claim 1, wherein the porous structure provides the plurality of volumes as pore volume and pore walls;
wherein openings of pores of the pore structure open towards the outer end plate layer and the abutting layer; and
wherein the pore walls extend traverse to the outer end plate layer and the abutting layer.

4. The end plate according to claim 1, wherein the porous structure comprises a honeycomb structure.

5. The end plate according to claim 1, wherein the core comprises cellulose.

6. The end plate according to claim 3, wherein the core further comprises reinforcement elements; and
wherein the reinforcement elements are configured to structurally strengthen the pores.

7. The end plate according to claim 1, wherein the reinforcement elements comprise a filler material, the filler material filling out at least a part of pore volume of the core; and
wherein the filler material is configured to provide for compressive strength, structural stiffness and electric insulation.

8. The end plate according to claim 3, wherein at least 50% of the pore volume comprises the filler material; and
wherein filled pore volume and unfilled pore volume are equally distributed across the porous structure.

9. The end plate according to claim 1, wherein the first fiber composite structure of the outer end plate layer comprises symmetrical fiber layers comprising fiber orientations of 0, +−45, and 90 degrees; and
wherein the first fiber composite structure makes the outer end plate layer quasi-isotropic.

10. The end plate according to claim 1, comprising at least one media port in a lateral portion of the abutting layer for supplying fuel to the cell assembly;
wherein the at least one media port is extending to an opposite face of the outer end plate layer; and
comprising a lateral cover block having at least one void forming the at least one media port running lateral to an end face of the core and the outer end plate layer.

11. The end plate according to claim 1, comprising a current collector for connecting cells of a cell assembly at least partially embedded in the abutting layer;
wherein at least a part of a surface of the current collector is exposed to face the cell assembly; and
wherein the abutting layer overlaps at least one side portion circle of the current collector providing an engaging mount.

12. A fuel cell, comprising:
a plurality of fuel cells arranged as a cell assembly;
a lower plate and an upper plate;
at least one fastening element; and
a plurality of current collectors;
wherein the cell assembly is between the lower plate and the upper plate;
wherein the at least one fastening element secures the lower plate and the upper plate against each other such that the cell assembly is fixedly held between the lower plate and the upper plate;
wherein the plurality of current collectors is between the cell assembly and the lower plate and the upper plate;
wherein at least one of the lower plate and the upper plate comprises the end plate according to claim 1; and
wherein the end plate faces the cell assembly with an abutting layer.

13. The fuel cell according to claim 12, wherein the lower plate and the upper plate are both provided as the end plate.

14. An energy supply system, comprising:
a fluid reservoir;
a fluid supply; and
the fuel cell according to claim 12;
wherein the fluid reservoir is configured to supply fluid, via the fluid supply to the fuel cell;
wherein the fluid supply is configured to be connected to the fuel cell;
wherein the fluid supply is configured to supply and discharge media;
wherein the end plates of the fuel cell are configured to provide access and connection for the fluid supply and electrical outlets to the fuel cell; and
wherein the fuel cell is configured to provide energy from the fluid by its electrical outlets through the end plates.

15. A method for manufacturing of end plates for a cell assembly, comprising:
providing a first layer forming an outer end plate layer;
wherein the outer end plate layer comprises a first fiber composite structure providing structural tensile strength in a plane orientation of the outer end plate layer and forming a supporting structure to an abutting layer and a core;
providing the core between the first layer and a second layer;
wherein the core is a sandwich core between the outer end plate layer and the abutting layer;
wherein the core along with the outer end plate layer provides a torsional and/or bending stiffness to the end plate;
wherein the core comprises a porous structure of a dielectric material comprising a plurality of volumes, the porous structure providing compressive strength;
providing a second layer forming an abutting layer for the cell assembly;
wherein the first fiber composite structure comprises a first fiber material and a second fiber composite structure comprises a second fiber material that is different than the first material;
wherein the abutting layer comprises the second fiber composite structure providing structural tensile strength in a plane orientation of the abutting layer;
wherein the abutting layer provides an electrical insulation for the abutting cell assembly, the abutting layer also providing a leak-tightness for media during operation of the fuel cell;
wherein the outer end plate layer and the abutting layer are each connected to the core in a laminar manner, such that a sandwich plate is formed; and
wherein a current collector is joined to the abutting layer and the abutting layer is formed to overlap on the edge of the current collector, such that a sandwich plate is formed.
